(19) United States
(12) Patent Application Publication
(10) Pub. No.: US 2023/0184425 A1
(43) Pub. Date: Jun. 15, 2023

(54) WOOD GAS BOILER

(71) Applicant: Martin Werner, Pinzberg (DE)

(72) Inventor: Bernhard Werner, Pinzberg (DE)

(21) Appl. No.: 17/924,275

(22) PCT Filed: May 11, 2021
(86) PCT No.: PCT/IB2021/053990

§ 371 Date: Nov. 9, 2022

(30) Foreign Application Priority Data
May 11, 2020 (DE) 10 2020 002 793.8

(51) Int. Cl. F23B 30/04; F23B 80/04; F23G 7/10; F23J 1/02

(52) U.S. Cl. CPC F23B 30/04; F23B 80/04; F23G 7/105; F23J 1/02

(57) ABSTRACT

The invention relates to a wood gas boiler having a boiler wall and a boiler bottom, at least one device for supplying air and at least one grating being arranged within the boiler wall and above the boiler bottom, and wood gas being produced in a firebed from wood chips on the grating, which wood gas can be extracted and/or conducted outwards, there being in the region of the firebed a star having a plurality of arms which extend in a star shape towards the boiler wall and can each be rotated about a rotational axis running radially with respect to the central vertical axis of the star.

### REFERENCE TO PENDING PRIOR PATENT APPLICATIONS

This patent application is a 371 national stage entry of pending prior International (PCT) Patent Application No. PCT/IB2021/053990, filed 11 May 2021 by Martin Werner and Bernhard Werner for WOOD GAS BOILER, which patent application, in turn, claims benefit of German Patent Application No. DE 10 2020 002 793.8, filed 11 May 2020.

The two (2) above-identified patent applications are hereby incorporated herein by reference.

### FIELD OF THE INVENTION

The invention relates to a wood gas boiler having a boiler housing which is preferably partitioned into a boiler bottom, a lower boiler jacket, an upper boiler casing and a boiler cover, wherein a device for supplying air is arranged within the boiler housing, as well as at least one grating, wherein wood gas is generated in a firebed from wood chips on the grating, the wood gas being extractable by suction and/or removable to the outside, wherein a star with a plurality of vanes is provided in the region of the firebed above the grating, the longitudinal vane axes extending in a star shape towards the boiler casing.

### BACKGROUND OF THE INVENTION

During the gasification of wood in a wood gas boiler, at temperatures of about 150° C., first, water vapor and oxygen are emitted by the employed wood chips, thereafter, at higher temperatures, solid constituents of the wood chips are gasified as well, in particular lignin and cellulose.

These gasified constituents are then subjected to partial combustion, where these organic constituents are oxidized to carbon monoxide (CO) at temperatures of 700° C. to 900° C. without ignition by means of an oxidizing agent that is added in limited amounts, for example air, which optionally results in further components such as hydrogen (H₂), carbon dioxide (CO₂), methane (CH₄) and water vapor (H₂O) as well as possibly a range of organic substances in varying concentrations. In addition to the wood gas as combustible producer gas, ash and possibly charcoal remain as solid residues which have to be removed from the wood gas boiler. Furthermore, at lower temperatures or on cooler surfaces, the water vapor, possibly mixed with organic constituents, may be able to condense to a tar or to a wood gas condensate and thereby gradually clog the wood gas boiler, such that this sort of condensation is to be avoided as much as possible.

A wood gasification process is characterized in particular by the so-called excess air coefficient λ. This coefficient is greater or equal to one (λ≥1) for complete combustion, equal to zero (λ=0) for pure pyrolysis, and generally lies between zero and one (0<λ<1) for the wood gasification occurring within the wood gas boiler 1 according to the invention. If the air or oxygen supply is temporarily interrupted completely, pure pyrolysis may take place, at (λ=0).

Wood gasification allows to usefully utilize excess wood as wood gas and employ the wood gas formed in this process for powering machines. The thus generated wood gas should be as pure as possible in all cases. The amount of contaminants generated when producing wood gas, in particular wood gas condensate such as tar, should be as little as possible, on the one hand, in order not to harm the environment, and on the other hand, in order to be able to maintain a continuous operation of the wood gas boiler between two successive cleanings which is as long as possible.

Because the deposit of wood gas condensate depends on temperature, the risk of deposit is highest in relatively cold zones within the wood gas boiler. This may be the result of an inconsistent air supply, such that cold zones emerge in corners or inaccessible locations of the firebed, where tar may form or be deposited. In addition, it has been shown that there is a radial temperature gradient within an upright wood gas boiler, the temperature usually being higher at the periphery than near the center.

Further it is desired that the wood gas boiler has the highest possible long-term conversion performance of wood chips into wood gas. In the case of traditional wood gas boilers it is certainly possible that fine unburnt coal particles clog the firebed zone after a longer phase of operation. Then the volume flow is reduced and the conversion performance may suffer. In particular, the aforementioned unwanted cold zones may form even directly within the firebed where not only the conversion performance is reduced, but also the tar-like wood gas condensate precipitates.

A generic wood gas boiler can be found in DE 10 2009 042 104 B4. The prior invention therein is based on the consideration that wood gas may be generated that is largely free of tar if the design is chosen such that the wood gas is extracted directly from the firebed zone and not from its outer edge or from the surface. The prior invention proposes a wood gas boiler wherein a star having a plurality of vanes is arranged in the area of the firebed that may be rotated about a central vertical axis. These vanes extend in a star-shaped manner towards the boiler casing and are embodied as suction channels that are open at the bottom for the transfer of wood gas. They each have a plurality of holes at the top for ingress of wood gas from the firebed, wherein the wood gas may exit again at their outer ends. This star is surrounded by a rim that may be rotated together with the star and has openings for accommodating the outer ends of the vanes, such that the wood gas exiting from the ends of the vanes may be suctioned out of the region between the rim and the boiler casing. The shape of the vanes is to ensure that wood and pieces of ember do not attach to them during operation. Accordingly it is provided, that these vanes are shaped in form of a roof having two upper roof surfaces inclined with respect to each other. The holes for ingress of the wood gas from the firebed are arranged in each of the two roof surfaces of the vanes. It has been shown, however, that the vane geometry known from DE 10 2009 042 104 B4 may be improved upon. This is because the region within the firebed above the ash grating is at risk that the ash clogs the openings in the vanes and further wood gas extraction is reduced, in particular, because, due to reduced convection, said undesired cold spots occur with increased precipitation of wood gas condensate, which clogs the openings in the vanes even more.

It is thus desirable to further develop a wood gas boiler of the type mentioned above, such that clean wood gas, free of solid and tar-like residues, is generated in continuous operation with a uniformly high conversion performance and that as little wood gas condensate, which clogs the wood gas boiler and leads to relatively cold zones, precipitates in the wood gas boiler as possible.

### SUMMARY OF THE INVENTION

With a wood gas boiler of this type according to the invention, it is therefore provided that the vanes of the star may each be rotated about horizontal axes of rotation that extend radially with respect to the central vertical axis of the wood gas boiler, in particular along the respective vane.

Because of this degree of freedom of motion, for example, openings in these radial vanes may be rotationally advanced at regular time intervals by an angle that is a fraction of 360°, for example, by 120° each, such that the spatial orientation of the respective openings is changed each time and thus the risk of a continuous clogging of these openings is removed. Rather, the force of gravity acts differently, depending on the pivot position of these vanes in the region of their respective openings. In addition, if these openings are located in the region of the underside of the respective vane, they may additionally be scraped off at an ash grating or the like.

The invention permits further development in that the vane-star is rotatable about a central vertical axis as well.

It has proven advantageous that at least one vane has an elongated shape having a longitudinal axis which is parallel or coaxial to the axis of rotation extending radially with respect to the central vertical axis of rotation of the respective vane. This elongated shape promotes the rotatability of a vane within the firebed, because such a vane is then narrower than long and cannot become jammed within the firebed.

A profiled shape of at least one vane contributes to largely constant force and environmental conditions along the profile.

The at least one preferably profiled vane may have a round or polygonal cross section. Above all, it is important, that there are no excessively exposed regions of the lateral vane face which may become jammed upon rotation about the longitudinal axis of the vane and thus damage the (rotation) mechanism.

It is within the scope of the invention that at least one vane has lamellae or other extensions protruding outwards. These extensions of preferably limited radial dimensions with respect to the longitudinal vane axis may be used to mix the firebed with a rotation of the respective vane.

According to the invention, it is furthermore provided that at least one vane is designed hollow, in particular as a hollow profile. Due to the elongated geometry, a cavity located within the vane may serve as a flow channel extending completely or largely in the radial direction and may, for example, vent wood gas from the firebed.

For this purpose—that is, the discharge of wood gas from the firebed—at least one vane is to have one or more openings in its lateral surface which allows the in- or outflow of wood gas into or from the respective vane. Thus, such a vane allows that large regions of the firebed—ideally along its entire radial dimension—directly discharge the wood gas formed there.

If—as further provided by the invention—at least one opening is elongate, wherein the longitudinal direction of the opening is preferably arranged transversely to the longitudinal axis of the respective vane, ingress of larger pieces of coal from the firebed into such a vane is impossible, and already in light of this aspect, this vane only exhibits a limited tendency for clogging.

The cavity within at least one vane preferably serves as a channel for transferring wood gas. In this aspect, it may even be part of a suction device, to actively remove the wood gas from the firebed.

Theoretically, both ends of a rotatable vane according to the invention may be configured for outflow of the wood gas. However, it is easier to discharge or remove the wood gas from the wood gas boiler from the radially outer end, thus the direction of flow within a channel in a vane is preferably directed outward, that is, towards the boiler jacket. As such, an opening at the radial outer end of the vane permits the outflow of the wood gas out of the respective vane.

The invention further provides that at least one vane is provided with a support extension at said vane's radially inner end face and/or at said vane's radially outer end face. These support extensions may, for example, have the shape of axle stubs, of which preferably at least one is to be hollow in order to allow the passage of wood gas. A support extension may e.g. also have a circular jacket shape. There are preferably two support extensions flush with each other at both front or end faces of a profiled vane, whereby only one of the two needs to be hollow.

At least one counterpart to a vane support extension facing the center of the wood gas boiler is to be arranged in the region of a central core or a hub of the star, in order to guide the respective vane at its end facing the center of the wood gas boiler. Preferably none of the vanes according to the invention extends up to or even through the vertical center axis of the wood gas boiler, but rather always ends in front of this center in some kind of core body or hub body, similar to the spokes of a wheel. Such a support counterpart may for instance be configured as a circular hole within such a core body or hub body, in order to accommodate the respective support extension, such that a structure similar to a friction bearing results. At the high temperatures in the region of the firebed, this simple way of support has proven better than complex ways of support.

Further, at least one counterpart to a vane support extension facing the boiler housing should be arranged in the region of a housing surrounding the star, which housing is preferably able to rotate synchronously with the star. If such a support counterpart is formed as a preferably circular hole in the housing, on one hand, the support is effected in a particularly simple fashion by inserting the respective support extension into this hole, and on the other hand, the wood gas is directed through the hollow support extension through the housing and thus leaves the firebed.

The housing enveloping the star should be rigidly connected to a central star or hub body within the star, in particular via a plurality of star-shaped spokes, preferably radial sheets. By thus ensuring synchronous motion between these parts, the rotating unit of core or hub body, star, and housing cannot be deformed nor jammed such that a permanently smooth rotary motion is ensured.

Furthermore, the invention recommends to provide the housing enveloping the star with one or more openings for outflow or suction of wood gas. These openings increase the outflow cross section of the wood gas beyond the cross section of the flow channels within the vanes according to the invention and thus promote the conversion of the wood chips to the desired wood gas.

Preferably the rotation of at least one vane is about its longitudinal axis or about an axis of rotation extending radially with respect to the vertical axis of rotation via a rotary drive coupled or coupleable with the respective vane. However, the actual drive unit should not be positioned within the wood gas boiler, in order to avoid damages due to the high temperatures. Further, not each and every vane has to have its own drive, ideally, a single drive is provided for all vanes together, which may be able to achieve other objects, for example the rotation of the star together with the core body and/or hub body and the housing.

It is within the scope of the invention that the driving is discontinuous for at least one vane.

The firebed should not be continuously in motion, such that regions of ember are not torn apart and the conversion of the wood chips into wood gas is not compromised. Rather it is preferred that the vanes rest for a period of time—for example for 10 to 40 minutes— and only thereafter, there is a rotation for a short period of time, which, however, should not lead to a full rotation of a vane, but only to a rotation over a fraction of 360°, such that different openings in the lateral face of the respective vane reach the top and the bottom in alternating fashion and are thus not at risk of clogging.

As a matter of principle, it is not necessary that the star and the rim rotate permanently. Accordingly, a further embodiment is characterized in that the star and the rim are rotatable at predetermined time intervals. Here, the star and the rim may be rotatable step by step. In operation, a drive has proven to be advantageous which is configured such that the star and the rim rotate for about one minute, after which about one quarter rotation has been covered, and such that the star and the rim are stationary for about 20 to 30 minutes thereafter.

A preferred embodiment of the invention is characterized in that the driving for at least one vane is derived from a rotation of the star. As was just mentioned, the rotation of the star is to be discontinuous as well, because this rotation about a vertical axis also mixes the firebed and may tear regions of the firebed apart that are in the process of smoldering entirely. Because both movements need not be continuous, there is the option of coupling both movements with each other. This has the further advantage that the vanes do not need their own rotary drive for their rotation, but may simply adopt the rotary motion of the star instead. The rotary motion of the star may, for example, be such that it rotates with each rotary motion only about an angle α=360°/n, where n is the number of vanes. Of course, this angle may be even smaller: α<360°/n, if the rotary movements take place at shorter time intervals. In case of longer waiting periods it is also possible that an angle of rotation is larger: α>360°/n.

The invention can be further developed to the effect that at least one vane is provided with a toothing whose teeth extend radially towards the longitudinal axis of the vane, such that at a particular rotary position of the star, one of these teeth engages with a preferably stationary finger or another barrier and thus rotates the vane further. The number m of stationary fingers or other barriers in the region of the toothing on the vanes may be chosen in various ways. On one hand, it may correspond to the number n of vanes: m=n, such that all vanes are rotated at the same time if the fingers are arranged at equidistant intervals on the circumference of the housing or boiler casing, with corresponding intermediate angles β:

β=360°/m.

The individual intermediate angles R may, however, be arranged to deviate slightly from this equidistant spacing, such that not all vanes are rotated at the same time, but rather temporally offset by a specific amount. This would have the advantage, that the rotary drive is not subjected to a pulsating load but is uniformly loaded during a rotation of the core.

For example, it can be provided that the star can be rotated together with the rim about a common vertical axis by means of a centrally located core pipe. Here, a drive ring located below the grating, an electric motor located outside of the boiler casing, and a shaft extending from the electric motor through the boiler casing into the boiler chamber is to be provided for driving the core pipe.

In order to remedy any malfunctions easily, a motor is to be selected that can selectively run forwards or backwards.

Preferably, in order to allow easy outflow of the resulting wood gas, the rim may be provided with a plurality of through holes for the passage of wood gas from the firebed, such that the wood gas enters into the region between the rim and the boiler casing. Then it is removed from this region by a pump for further use, for example for driving a motor.

In case of a two-part boiler insert consisting of an upper, preferably stationary boiler casing and a lower boiler casing ending in a gap thereto, wherein the latter may preferably be formed by the possibly rotationally supported rim of the star, an annular seal can be arranged in the region of said gap between the lower end of the upper boiler casing and the upper end of the lower boiler casing, said seal having a sealing element made of a metal strip curved into the shape of a cylinder jacket, the metal strip being arranged concentrically with a central axis of the upper boiler casing. This seal, on the one hand, is to prevent wood chips as well as coal particles and ash particles from exiting the firebed region to the outside, on the other hand, is to allow removal of the generated wood gas.

Preferably, said sealing element has a plurality of radial spacers arranged along its circumference which hold the sealing element at a radial distance from the upper boiler casing. These spacers ensure immediately in the region of the gap that said gap cannot expand sectionally in the radial direction as the result of an eccentric displacement of the insert or the lower boiler casing with respect to the upper boiler casing. Thus the remaining gap between the sealing element according to the invention and a local section of the boiler casing remains at a constant width everywhere and cannot expand in individual sections. Accordingly, larger coal or ash particles are not able to enter into and clog this remaining gap.

It was found advantageous that the radial spacers are fixed to the sealing element and protrude radially towards the upper boiler casing. These spacers may be welded or screwed on, for example. A fixing of this type ensures that they cannot be displaced with respect to each other or even come loose due to the effects of heat and/or larger (clamping) forces.

The planar shape of the radial spacers at the sealing element that lies within a vertical radial plane results virtually only in a small, web-like narrowing or interruption of the circumferential gap such that it still allows maximum throughput of wood gas.

The invention recommends that the sealing element is integrated neither with the upper boiler casing nor with the lower boiler casing. This allows to provide a passage for outflowing wood gas at each of the transition from the sealing element to the upper boiler casing and the transition from the sealing element to the lower boiler casing.

In further pursuit of this idea, it may be provided that the sealing element has a plurality of webs at its lower end face arranged along its circumference protruding vertically downwards and rests with these webs on the upper edge of the lower boiler casing. Thus, between adjacent webs, one flow channel each remains free.

The lower boiler casing may be shaped as a flat annular disc where the sealing element rests with its vertically downward protruding webs, to avoid slipping of the webs from the upper edge of the casing. The radial width of this flat annular disc may e.g. correspond to three times or more of the radial width dimension of the annular sealing means, preferably five times or more of the radial width dimension of the annular sealing means.

Further advantages result from the lower boiler casing being rotatable with respect to the upper boiler casing, in particular about a central vertical axis of the wood gas boiler. In this case, the lower boiler casing may be provided with inwardly projecting arms, beams, vanes or the like, which circulate the coal and ash particles within the firebed upon rotation of the lower boiler casing and thereby provide a uniform glowing fire.

Following this inventive idea, the invention further provides that the lower boiler casing is formed by an outer rim of a rotatable insert in the shape of a cylinder jacket above the ash grating. If not only the lower boiler casing, but a whole insert in the lower region of the wood gas boiler is rotatable, the rotary drive may be effected via a central axis, or at least near a central axis, which may possibly simplify the design.

The invention is further characterized by a driver which engages with the gap between the two ends of the annular sealing element curved from a metal strip and is fixed to a support element, for example a boiler casing, such that the annular sealing element cannot be rotated with respect to the respective support element. While the webs on the underside define the height of the sealing element along a vertical axis of the wood gas boiler and the radial spacers define the element's horizontal position or concentricity with respect to this vertical axis, said driver is to define the angle of rotation of the sealing means about said vertical axis. The driver couples this angle of rotation with the respective support element. By preferably employing a fixed boiler casing for this purpose, there a relative rotary motion occurs between the likewise non-rotated sealing element and an, e.g., rotatable insert on which a sealing element is supported by its bottom webs. This relative motion in turn ensures that no coal or ash particles may be jammed in the recesses between the bottom webs.

The driver may optimally be inserted into the gap between the two ends of the annular sealing element curved from a metal strip, if said strip has a tab having a planar shape which lies in a vertical radial plane with respect to the central axis of the wood gas boiler.

If—as is further provided by the invention—the driver or its planar tab has ridges or extensions protruding tangentially with respect to the sealing element curved into the shape of a cylinder jacket, which ridges or extensions guidedly envelop the sealing element curved into the shape of a cylinder jacket at its inner and/or outer sides, this prevents that the sealing element curved from a metal strip is able to curve away from the support element, for example, whereby its sealing capabilities could suffer.

Furthermore, a wood gas boiler of this type may be provided with a central core in the shape of a jacket, which encloses a central region of the wood gas boiler and has at least one circumferential series of openings or through holes to allow an exchange of wood chips and charcoal between the central region within said core and a peripheral region outside the core of the wood gas boiler. The lateral surface of said core thereby forms a partition of some sort between two substantially independent regions, namely, said central region and said peripheral region, such that in the event that one of these regions is clogged, the respective other region creates a type of bypass which still allows the removal of the wood gas, wherein the holes in the respective partition allows a local transversal flow within the unclogged region which carries away particles from the clogged region and thus dissolves an emerging clumping.

The lateral surface of said central core may be located at the level of said peripheral sealing element. The ember region within said wood gas boiler is divided into four regions total, on one hand by a plane spanned by the sealing element within the gap and on the other hand by the lateral surface of the central core, namely into an upper region outside of the core, an upper region within the core, a lower region within the core, and a lower region outside of the core. Preferably, this sequence also defines the passage of wood chips through the wood gas boiler. The wood chips reach an upper boiler region above the ember region after insertion, for example through an inlet port at the top. From there, preferably through a coarse filter, they reach the actual ember region, namely its upper region outside of the core. From there they may be led, for example via a funnel-shaped guide, towards a series of upper through holes of the central core, where they enter the core, that is, initially the upper core region. There they sink downwards to the lower core region where they are able to leave the central core again through a second series of lower through holes and are deposited directly into the firebed outside of the core. There, the lower peripheral region of the ember region is enveloped by a rotatable rim and is stirred by the preferably rotatable star, while the upper peripheral region outside of the core is enveloped by a stationary boiler casing and thus is not actively stirred.

Depending on the embodiment, the central, jacket-shaped core of the wood gas boiler may have a rotationally symmetric or cylindrical shape, preferably a circular cylindrical shape, or a prismatic shape, preferably having a cross section in the shape of a regular polygon.

In order that the core within the wood gas boiler keeps its shape even in harsh operating conditions, the lateral surface of the core may be reinforced by vertical ribs or beam-like supports or sheets, preferably extending along the inside of the lateral surface of the core.

A preferred design specification prescribes that the outer diameter or the mean outer diameter of the central, jacket-shaped core of the wood gas boiler corresponds to at least one third of the boiler diameter in the region of the upper boiler casing. Thus, the space within the central core has a cross section of about one sixth of the space outside of the central core. Such a cross section is necessary so that the interior of the core does not tend to clog or clump. On the other hand, the firebed as such is located radially outside of the central core, such that the core should not be chosen too large in order to produce a sufficient amount of wood gas. It is thus recommended to choose the outer diameter or the mean outer diameter of the central, jacket-shaped core of the wood gas boiler not larger than half of the boiler diameter in the region of the upper boiler casing.

The central, jacket-shaped core of the wood gas boiler may be traversed vertically by a central rod or shaft in order to ensure smooth movability of the rotating components within the wood gas boiler.

It has been shown that it is advantageous that the central, jacket-shaped core of the wood gas boiler is closed off, or stabilized and/or reinforced at the bottom by a circular, polygonal and/or annular base plate. This base plate is to prevent direct dropping of the wood chips in the core onto the ash grating; rather, the wood chips and other particles are forced to exit the core via the lower lateral through holes and pass from there directly into the firebed, where they are then converted into wood gas.

Below the base plate of the central, jacket-shaped core of the wood gas boiler, a mechanism may be arranged which is able to put the rotatable insert and/or the central core into rotary motion about the central vertical axis of the wood gas boiler. Preferably, the actual drive for this mechanism is located outside of the wood gas boiler.

Following the regular passage of wood chips through the boiler from a top inlet port down to a bottom ash grating, a first circumferential series of upper through holes is arranged in the core's lateral surface for ingress of wood particles, coal particles and/or ash particles into the core. These upper through holes are preferably located at the level of the upper, non-rotatable boiler casing.

A second circumferential series of through holes in the lateral surface, however, serves for egress of the wood particles, coal particles and/or ash particles from the core. These lower through holes are located of a rotatable insert whose peripheral cylindrical jacket extends the upper boiler casing, preferably having a sealed gap therebetween.

Preferably one of the upper through holes each is arranged flush with a respective lower through hole.

Regarding the shape of the through holes, a geometry has been proven advantageous, where the width of a through hole in the lateral surface of the core in the lower region of the respective through hole is constant and tapers in its upper region from bottom to top. Because the wood chips and coal particles move from top to bottom within the wood gas boiler, they encounter a steadily increasing width of the opening in the lateral surface of the core during a vertical settling motion. The downwards diverging lateral edges of the through holes serve the purpose of directing even larger particles through these through holes without occurrence of clogging.

To pursue this inventive idea further, it may be provided that the through holes in the lateral surface of the core are shaped in the manner of a triangular, rectangular or pentagonal window or in the manner of an arched window.

Furthermore, the lateral surface of the core may be enveloped by a bell-shaped or funnel-shaped or conical body at a level between the upper through holes and the lower through holes. These are guides to direct the flow of wood chips within the wood gas boiler. If the bell-shaped or funnel-shaped or conical body enveloping the central, jacket-shaped core of the wood gas boiler expands from bottom to top, the wood chips above such a funnel are directed towards the central core and the pressure in the region of the upper through holes is increased.

If the lateral surface of the central, jacket-shaped core of the wood gas boiler above the bell- or funnel-shaped or conical body is surrounded by a filter, in particular a coarse filter, the wood chips or other particles passing through said filter are largely directed directly to the central core and in turn delivered by the core uniformly to the firebed.

Further it is within the scope of the invention that the central, jacket-shaped core of the wood gas boiler is also closed off or stabilized and/or reinforced at its upper end, preferably by a circular, polygonal and/or annular upper end wall. A planar disc shape of this upper end wall increases the stiffness of the apparatus against mechanical stress.

Finally, clumping can not only occur in the region of the ember zone, but also above this region, in particular above a central region which is created by a partition in the lower region of the boiler and separated from a peripheral region of the boiler. Therefore, the invention provides a central condensate deflector, which covers a central region within the boiler and is to prevent a deposit of wood chips and/or charcoal in this region.

The top circular, polygonal, and/or annular end wall in particular allows placing the condensate deflector there. In particular, the peripheral edge of such a condensate deflector may rest all around on the upper end wall of the central core and thus be prevented from tilting.

A geometry with a top side of the condensate deflector which is arched upwards in the central region contributes that condensed, but still flowable wood gas condensate flows down along the condensate deflector and thereby also radially outward, that is, into regions with a higher temperature where the wood gas condensate may be cracked and thereby rendered gaseous.

A concrete embodiment of the condensate deflector according to the invention provides that it has a cup-, hood-, cap- or cone-like shape. These shapes meet the prerequisite of a raised central region and an upper surface that continuously declines from there to the periphery of the condensate deflector and are therefore able, in case of wood gas condensate precipitate, to discharge the precipitate due to the force of gravity to the outside in the region of the wood gas boiler, where higher temperatures lead to cracking of the wood gas condensate precipitate.

Because the condensate deflector covers a central region within the wood gas boiler, clumping cannot form on the smooth surface of the condensate deflector; rather, wood gas condensate which is generated there is drained along a slanted surface to peripheral regions of the wood gas boiler, whereby, in addition, the wood gas condensate is cracked. This prevents the formation of a clumped core from where clumping could spread.

In particular, the condensate deflector is to cover said central, jacket-shaped core of the wood gas boiler and/or its upper circular, polygonal, and/or annular end wall at the core's periphery completely, such that wood gas condensate may not precipitate there.

It has proven advantageous that the condensate deflector has a planar or annular region surrounding a central axis of the wood gas boiler and having a closed surface. In the actual center, the condensate deflector is preferably traversed by a central vertical axis of the wood gas boiler resulting in the preferred annular shape.

The planar or annular region of the condensate deflector with a closed surface is to be point symmetric or rotationally symmetric such that it is in force equilibrium and fixing is possible with moderate effort.

It is within the scope of the invention that the planar or annular region with a closed surface is elevated near its center or near its inner edge with respect to its periphery or its outer edge. An upper side of the condensate deflector which is arched upwards in the central region contributes that condensed, but still flowable wood gas condensate flows down along the condensate deflector and thereby also radially outward, that is, into regions with a higher temperature, where the wood gas condensate may be cracked and thereby rendered gaseous.

Further advantages result when the outer diameter of the condensate deflector or of its annular region corresponds to one third or more of the boiler diameter in the region of the upper boiler casing. Thereby, a correspondingly large surface area in the region of the center of the boiler may be protected from undesired wood gas condensate precipitate.

A filter, preferably an annular filter, in particular a coarse filter for retaining larger pieces of wood or coal, may be arranged at a level below the condensate deflector. Because such a filter, preferably extending horizontally, reduces both air circulation and gas circulation, in particular between a region above the filter and a region below, as well as the influx of thermal radiation, a region above this filter is usually cooler than the region of the wood gas boiler below such a filter. This in turn leads to a significantly increased risk of precipitate of wood condensate in the region above such a filter; for this reason, a condensate deflector according to the invention is to be arranged above such a filter as well.

The invention recommends providing the condensate deflector at its outer perimeter with at least one extension radially protruding with respect to a vertical axis of symmetry of the wood gas boiler, which may serve to scrape off or strip off contaminants from the top of the filter located underneath.

In order to achieve this task of scraping off contaminants from the top of the filter located underneath, the condensate deflector is to have a different rotational speed than the filter below, for example a rotational speed in the opposite direction.

A defined specification of the angle of rotation and/or the rotational speed of the condensate deflector is enabled by coupling the condensate deflector with a vertical shaft in the region of its center or of the inner edge of its annular region in a rotationally fixed manner and by fixing or driving the deflector in the direction of rotation by means of this vertical shaft. While a drive is necessary to change the angle of rotation, a localization of the vertical axis is sufficient to specify a constant angle of rotation.

The invention may be developed further to the effect that the condensate deflector rests, via its annular region, on a structure located underneath and is being supported and/or stabilized in its position by said structure, in particular on top of said central core or an upper end face thereof. This support may be advantageous, if the condensate deflector has to support the weight of a higher layer of filled wood chips during the operation of the wood gas boiler.

In order to ensure a good conversion of wood chips to wood gas without incinerating them, the wood gas boiler is to have an inlet port at the top, which is provided for the ingress of the wood chips and allows an air-tight seal.

It should be emphasized that the air supply in the ember zone is substantially uniform with respect to the aforementioned central axis. This is easily achieved, for example, by positioning the firebed within an ember region having a substantially cylindrical wall, in which a number of air nozzles are arranged in a distributed manner.

Just above the boiler bottom, a co-rotating ash remover may be fixed at the lower portion of the support pipe for removing the fallen ash towards an ash duct opening. This ash remover may be shaped like a spider and have a plurality of scraper bars spaced apart with, e.g., round, rectangular, or L-shaped cross section.

Of course, the generated ash must be removed from the wood gas boiler at intervals. Accordingly, the boiler bottom is to be provided with an ash duct opening below which a device for removing the fallen ash is positioned, for example an ash container. This device is to also conveniently comprise a conveyor screw.

### BRIEF DESCRIPTION OF THE DRAWINGS

Further characteristics, features, advantages, and effects based on the invention will be apparent from the following description of some preferred exemplary embodiments of the invention and by reference to the Figures. In these:

FIG. 1 shows a vertical cross section of a wood gas boiler according to the invention having a lower, preferably cylindrical boiler housing and an upper boiler casing placed thereon having cylindrical geometry as well, which is, however, tapered with respect to the boiler housing, where various internals of the wood gas boiler may be seen, in particular a rotatable core and a rotatable insert;

FIG. 2 shows a slightly modified embodiment of the invention compared to FIG. 1, where the internals within the lower boiler housing with the upper boiler casing removed are shown obliquely from above, in particular the rotatable core and the rotatable insert having a plurality of radially extending profiled structures;

FIG. 3 shows the rotatable insert of FIG. 2 in the removed state and with the profiled structures removed, in a perspective view from above;

FIG. 4 is a side view of the rotatable insert of FIG. 3 with mounted profiled structures, in partial sectional view;

FIG. 5 shows the detail V of FIG. 4 in an enlarged view;

FIG. 6 is a perspective view of an assembly from the inside of the wood gas boiler of FIG. 1, comprising the rotatable core and the rotatable insert as well as an upwardly curved rim of the ash grating;

FIG. 7 shows a coarse filter which may be placed onto the core of FIG. 6 to retain larger charcoal pieces, as well as a cover in form of a condensate deflector which may be placed on top of this coarse filter, again in a perspective view;

FIG. 8 shows a vertical cross section of an annularly curved sealing element for sealing a circumferential gap, on one hand between the upper boiler casing, and on the other hand the rotatable insert of FIG. 2, assembled with the wood gas boiler;

FIG. 9 shows a plan view of FIG. 8 in the direction of arrow IX with the sealing element mounted in the wood gas boiler; and

FIG. 10 shows an enlarged view of detail X of FIG. 8.

### DETAILED DESCRIPTION OF THE PREFERRED EMBODIMENTS

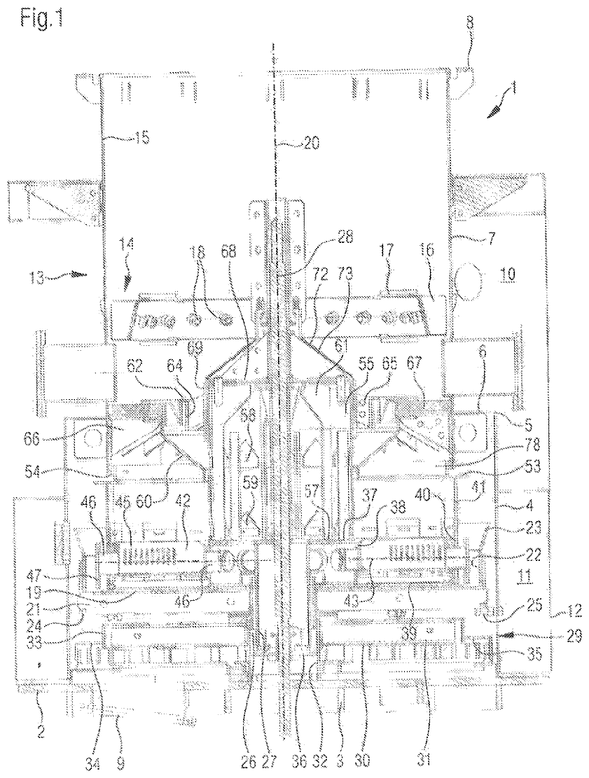

In accordance with FIG. 1, a wood gas boiler 1 according to the invention has an approximately vertical through flow and is filled with wood chips from the top, whereas ash is removed at its bottom end. In between, the generated producer gas may be extracted.

In order to enable a continuous process, it must be ensured, on one hand, that a regular infeed is possible without enabling the producer gas to be discharged uncontrollably, on the other hand, that ash is removed continuously or at regular time intervals. As already indicated above, it should also be ensured that no wood gas condensate or tar precipitates within the wood gas boiler 1, if possible.

In order to extract the generated producer gas in defined fashion, the wood gas boiler 1 according to the invention is sealed off to the outside in a more or less air-tight manner.

For this purpose, the wood gas boiler 1 is provided with a boiler bottom 2, for example, in form of a steel plate, which may be reinforced by means of a bottom frame or webs 3 that are welded to the bottom. A lower boiler jacket 4, preferably cylindrical in shape, rises above this boiler bottom 2. This boiler jacket 4 does not extend, however, directly to the upper end of the wood gas boiler 1, rather, it is connected in air-tight fashion at its upper edge 5 via an inwardly oriented, local flange 6 to a boiler casing 7, which is offset radially inward and extends further upward up to the upper end of the wood gas boiler 1. There, an attachment means for a boiler cover is preferably provided, preferably in the form of a circumferential flange 8.

An inlet or feed port may be integrated with or connected to the boiler cover, via which wood chips may be filled into the wood gas boiler 1 from above without the producer gas being able to escape in an uncontrolled manner.

An outlet port 9 in the boiler bottom 2 enables the removal of ash from the wood gas boiler 1 at regular time intervals.

The supply of air or another oxidation means as well as the removal of the generated producer gas is effected via a pipe connection, not shown in the drawings, in the boiler casing 7 and/or the boiler jacket 4.

The shape of the wood gas boiler 1 is preferably rotationally symmetric or prismatic, for example having a horizontal cross section in the shape of a circle or a polygon, more preferably a uniform quadrangle.

For example, for the purpose of thermal insulation, the boiler jacket 4 and/or the boiler casing 7 may be surrounded outside by one or more annuli 10, 11, which are delimited to the outside by an outer wall 12. Preferably, the outer wall 12 rests on and is supported by an edge of the boiler bottom 2 that protrudes out of the boiler housing 4.

In addition to the hitherto described boiler housing 13 of the wood gas boiler 1, the boiler has various internals which mostly serve the purpose of enabling continuous operation with the most constant possible producer gas yield.

Like the hitherto described components of the wood gas boiler 1, which are rigid and stationary, there are also rigid and stationary internals. In this regard, an air supply 14 must be noted, which is located approximately halfway up the boiler casing 7 at its inner side 15. This is a circumferential annular air duct 16 for the supply of air. This annular air duct 16 may be held by means of clamps 17 or other support elements to the inner side 15 of the wood gas boiler 1. Preferably, this circumferential air duct 16 has a rectangular or trapezoidal cross section, preferably a trapezoidal cross section which expands from bottom to top such that the radially inner side 17 of this air duct 16 follows a conical shape along an upwards tapered frustum. At this preferably conical inner side 17 of the annular air duct 16, there are annularly distributed outlet openings or outlet nozzles 18. Due to the preferably conical shape of this inner side 17, the outlet nozzles 18 are tilted downwards to a certain degree, such that the supplied air is blown out downwards.

Another rigid and/or stationary internal component within the wood gas boiler 1 is an annular ash grating 19, which rests on a substructure consisting of support arms 21 that extend radially outward from a central axis of symmetry 20. These support arms 21 may be connected to a skirt 22 enveloping the ash grating 19 on the outside and extending largely upwards, which may expand outward in conical shape in its upper region 23. A lower edge 24 of this skirt 22 rests preferably on stub-shaped support elements 25, which are anchored in the boiler housing 4, preferably with equidistant spacing.

The radial inner ends of the support arms 21 are connected—in the manner of the connection of spokes of a wheel to a central hub—to a sleeve 26, which may in turn serve as a guide for a cylindrical element 27 in the center of the wood gas boiler 1. The cylindrical element 27 extends upwards through the central recess in the annular ash grating 19 and in turn envelops a shaft 28 protruding upwards from the boiler bottom 2 along the vertical axis of symmetry 20 of the wood gas boiler 1. This shaft 28 is preferably non-rotatably fixed in the boiler bottom 2, however, in specific embodiments, may be supported to be rotatable about its longitudinal axis or about the axis of symmetry 20.

Contrary to the non-rotatable internals just described, such as the air supply 14, the ash grating 19, and possibly the vertical shaft 28, the cylindrical element 27 is preferably rotatable about the vertical axis of symmetry 20 of the wood gas boiler 1. This element 27 is rotationally driven by means of a rotation device 29 below the support arms 21.

This rotation device 29 is preferably integrated with an ash remover 30, which feeds the lowest ash layer with one rotation gradually to the outlet port 9 arranged peripherally or eccentrically in the boiler bottom 2. This ash remover 30 comprises a plurality of rods or pipes 31 extending radially outward in a horizontal plane, which are connected, preferably welded, to a radially inner sleeve 32. The sleeve 32 is supported in an annular recess on the upper side of the boiler bottom 2 in the manner of a slide bearing to be rotatable about the vertical axis of symmetry 20. A perforated cover 33 is rotationally fixedly connected to the rods or pipes 31 of the ash remover 30, which cover is provided in turn with an annular series of holes 34 in the region of the peripheral ends of the rods or pipes 31, such that the remaining webs 35 between these holes 34 are suitable for engaging by a driving means in the manner of a sprocket. On one hand, a gear or similarly toothed wheel, not shown in the drawings, may serve as the engaging driving means, which is rotated by a specific angle at regular time intervals, or a hook-shaped driving means, which is pushed forward at regular time intervals until the hook engages with a free hole 34 and is then pulled back, in order to further rotate the ash remover 30. The sleeve 32 is rotationally fixedly connected with the cylindrical element 27 via a plate 36 extending inwards.

The cylindrical element 27 rotationally driven in such a way is in turn connected with a hub-shaped element 37—which may also be hollow according to the enclosed drawings—in a rotationally fixed manner and has a cylindrical outer face 38. Beyond this outer face 38 in cylinder-jacket shape, several sheets 39 protrude in planar fashion radially outward in a horizontal plane. The peripheral ends 40 of these sheets 39 are vertically curved upwards and connected to a jacket 41 extending upwardly in the shape of a skirt.

Between this cylindrical outer face 38 of the hub-shaped element 37 and the peripheral jacket 41, a plurality of profiled elements or vanes 42 extend in the manner of radial spokes, with longitudinal axes 43 extending respectively radially with respect to the central axis of symmetry 20. Preferably, one profiled element 42 each extends parallel or above a radial sheet 39, such that overall the shape of a star 44 of vanes 42 results.

Each of the profiled elements or vanes 42 is preferably hollow, preferably each having one radially expanded middle section 45 and at both ends support extensions or axle stubs 46 correspondingly tapered in cross section. These axle stubs 46 are supported each in a bore in at least one of the respective sheet 39, the hub-shaped element 37, and the peripheral jacket 41, preferably in the manner of a slide bearing.

One toothing 47—for example in the shape of a star or a sprocket—each is fixed to the radially outer axle stub 46, whose beams or teeth 48 come in contact with fingers 49 or other barriers at or within the skirt 22 connected to the ash grating 19 upon one rotation of the peripheral jacket 41 and are moved further by these fingers by one tooth pitch or beam pitch of the toothing 47.

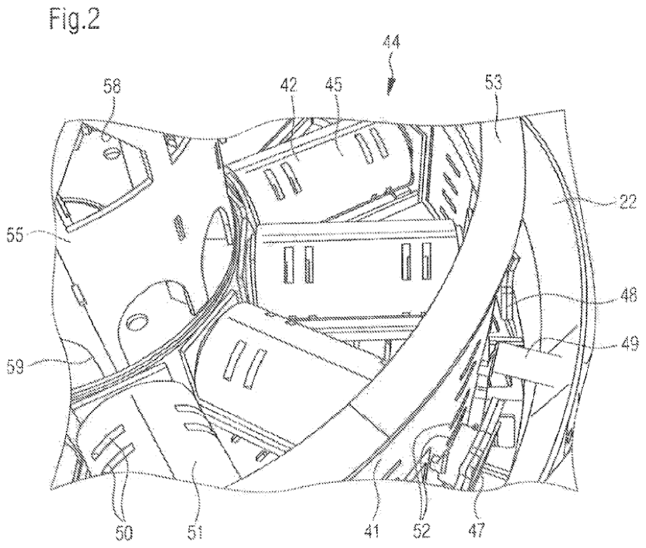

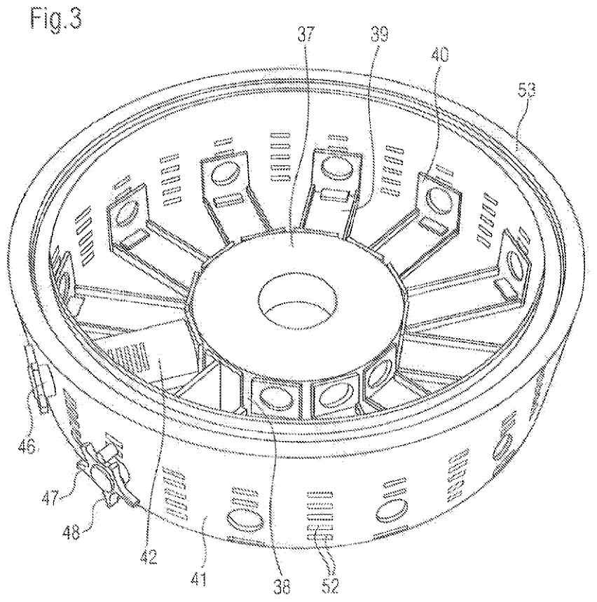

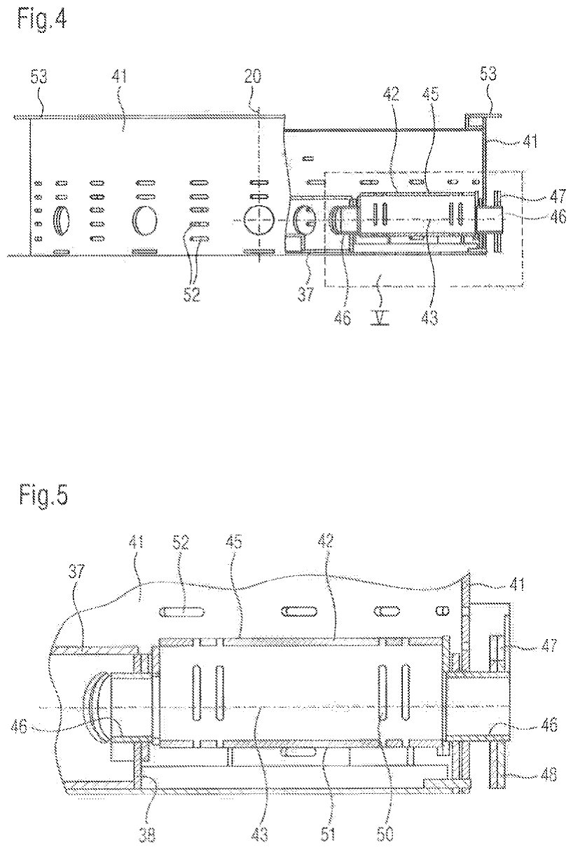

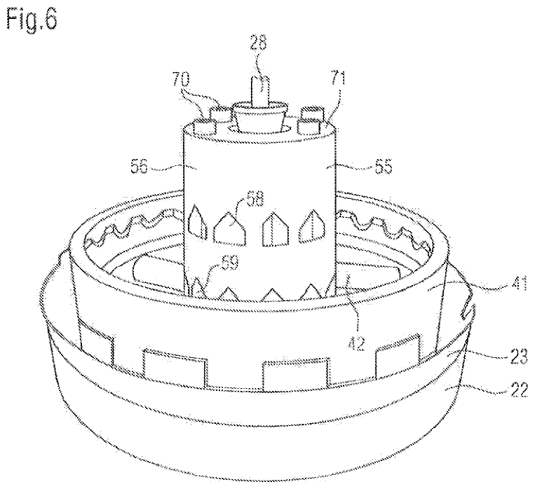

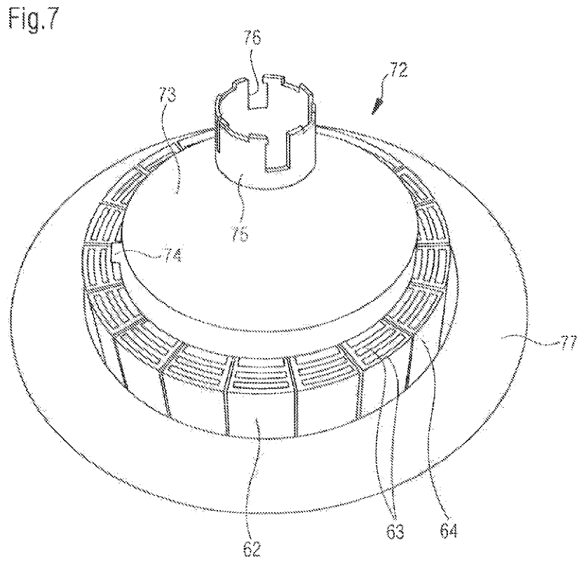

FIG. 2 shows that the individual vanes 42 of the star 44, which is rotatable about a vertical axis, are again embodied in a rotatable manner, about their respective longitudinal axis 43. For this purpose, each vane 42 has a middle section 45 which extends on one hand between the central core 55 and on the other hand the peripheral rim 41, but tapers to a respective support extension 46 in front of each respective element 55, 41, which support extension is rotatably supported in the respective element 55, 41, in particular in the manner of a friction bearing. The outer support extension 46 may pass through a corresponding support opening in the rim 41. Outside of the rim 41, the outer support extension 46 supports a star-shaped toothing 47, which is connected with the support extension 46 in a stationary, that is, rotationally fixed manner. Due to the rotation of the star 44, the star-shaped toothing 47 of each vane 42 reaches the region of the stationary finger 49, which is, for example, fixed on the upwardly protruding skirt 22 of the ash grating 19 in a radially inwards protruding manner, successively at a particular time. Upon further rotation of the star 44, this finger 49 regularly comes into contact with a toothing 47 of a vane 42 and effects a pivot of the respective vane 42 by an angle corresponding to the angular pitch of the star-shaped toothing 47, that is, in the case of a star-shaped toothing 47 having k tips or teeth 48 about a respective angle α of α=360°/k each time.

As can be seen in the drawings, a vane 42 may be designed as a profile with a constant cross section in its middle section 45; however, other embodiments are contemplated; for example, the cross section of the middle section 45 may change; the middle section 45 could, e.g., be composed of a plurality of discs having different geometries, etc. The middle sections 45 of the profiled elements 42 may each have a cylindrical or prismatic shape, for example with a circular cross section or a polygonal cross section.

Furthermore, a vane 42 is preferably hollow in its middle section 45; this channel-shaped cavity may also extend up to and into the support extensions 46. If the lateral surface 51 of a hollow middle section 46 has openings 50, for example slotted openings 50, then the wood gas may enter through these openings 50 into the internal channel of the vane 42 and, for example, exit again at the outer end of a support extension 46 outside of the rim 41, where it may be suctioned off by negative pressure. A series of these openings 50 in the lateral surface 51 of the middle section 45 of each profiled element or vane 42 allows the ingress of producer gas from the firebed. This producer gas may be transported either radially to the outside or radially to the inside within each respective profiled element or vane 42.

Here, the rotation of the profiled elements or vanes 42 ensures that the lateral openings 50 may not clog. In particular, in the case of a prismatic profile body 42, the rotation may additionally ensure that remaining pieces in the ash are ground in the firebed and/or that the ash is transported through the ash grating 19. Thereby, edges of such a prismatic profiled body 42 may serve as stripper edges in order to swipe off ash lying on the ash grating 19.

The jacket 41 may be provided with additional openings 52 through which producer gas may exit to the outside as well.

Between the upper edge 53 of the jacket 41 and the lower edge 54 of the cylindrical boiler casing 7, a small gap remains as clearance, which allows relative movement between these two components. This gap may be sealed, for example by a labyrinth seal, such that no air can escape, if possible, and the maximally pure producer gas can be extracted to the outside only in the lower region of the firebed.

During operation, there is a thermal gradient within the wood gas boiler 1 in a horizontal plane from radially outside to the inside, that is, the temperature is highest near the boiler casing 7, and the temperatures are lowest near the axis of symmetry 20. There, that is, near the central axis of symmetry of the wood gas boiler 1, the gasification could be incomplete—moreover, in and near these central regions tar-like wood gas condensate could precipitate and impair the further progress of the gasification process, such that an operating cycle between servicing and cleaning operations would be shortened. For this reason, it is provided that there is no gasification in the central region of the wood gas boiler 1, if possible. For this reason, a central core 55 is provided in the wood gas boiler 1, which is to suppress any gasification processes there as much as possible.

The central core 55 has the shape of a vertical cylinder jacket 56 with a longitudinal axis that is coaxial with respect to the axis of symmetry 20 and a horizontal base 57 which rest on top of and is connected with the rotationally driven, sleeve-shaped element 27 in a rotationally fixed manner. Thus, the core 55 rotates synchronously with the star 44 of radial profiled elements or vanes 42. The central core 55 serves as a type of perforated partition 56 and has a, for example, cylindrical or prismatic shape for this purpose, which at least partially separates a central region of the wood gas boiler 1 from a peripheral region thereof.

This enveloping core 55 has two levels with through holes 58, 59 arranged in a ring. As can further be seen from the drawings, the jacket 56 has a plurality of through holes 58, 59. In particular, there is an upper circumferential series with a plurality of through holes 58 and a lower, again circumferential series with a plurality of through holes 59.

The geometry of these through holes 58, 59 may largely be chosen arbitrarily; each through hole 58, 59 may, for example, be shaped in the manner of a triangular, rectangular or pentagonal window or in the manner of an arched window. Preferably, the width of a window is constant in its lower region and tapers continuously upwards. In the embodiment of FIG. 2, the upper through holes 58 have a pentagonal geometry, the lower through holes 59, however, have a geometry similar to an arched passage.

At a level between the upper series of through holes 58 and the lower series of through holes 59 the outside or the jacket 56 of the core 51 is enveloped by a funnel-shaped element 60. The funnel-shaped element 60 may rest on the webs 66 with its peripheral edge.

From there, the funnel-shaped element 60 extends upwards and expands conically from bottom to top and thus guides wood chips from above radially inwards to the upper series of through holes 58, where the wood chips then enter the core 55 and from there leave through the lower series of through holes 59 radially outwards finally into the actual firebed. Preferably, the core 55 has inwardly protruding ribs 61 on its inside. The inner region within the funnel thus forms some sort of bypass for an additional peripheral region within the wood gas boiler 1, if any, and allows the wood gas and any charcoal or ash particles that are carried along to find a way to unclogged lower through holes 59 and then leave the central core 55 again in radial direction and reach the grating 19 from there, whereas the wood gas may find its way through the openings 50 into the internal channels within the vanes 42 and exit, for example at the outer ends of the support extensions 46 outside of the rim 41. This is also to avoid a local compaction of the combustible material and thus the risk of locally incomplete combustion due to lack of sufficient gas inflow or outflow. The goal here is, in particular, to avoid an inhomogeneous temperature distribution with cold zones, where wood gas condensate would increasingly precipitate.

The central core 55 may partially be closed off at the top by an annular top face 71, where a cover 68 with an annular coarse filter 62 may be placed. This top face 71 may, for example, be provided with four receptacles 70 for inserting pins 69 at the underside of the cover 68. The coarse filter 62 is arranged above the funnel-shaped element 60 placed on the outside 56 of the core 55 and is to prevent ingress of wood chips that are too large into the region of the firebed.

This coarse filter 62 has a greater number of vertical webs 63 and channels therebetween which are arranged in an annular manner surrounding a central region of the cover 68 serving to be placed on top of the top face 71 of the core 55. Due to their cross section, these channels limit the size of charcoal pieces passing through to particle diameters of, for example, approximately 1 to 2 cm. For this purpose, the annular webs 63 extend concentrically to each other at a small radial distance of, for example, 1 to 3 cm and are, for instance, held at a distance by radial webs 65. The width of the gap of the annular openings between these webs 63 as well as between the outermost web 63 and an outer rim 64 defines a maximal dimension of wood chips that may pass therethrough.

These webs 63, 64 may either rotate together with the core 55 or may be anchored to the boiler casing 7, for example via webs 66 protruding radially inward. It is also contemplated that radial inner webs 63 co-rotate due to their mounting webs 65 anchored to the lateral surface 56 of the core 55, whereas radially outer webs 64 of the coarse filter 62 are anchored to the boiler casing 7 and thus do not co-rotate, such that there is a relative rotation between two opposite webs 63, 64 and wood chips that are too large are being crushed by this rotation.

Webs 66 protruding inwards from the boiler casing 7 may also serve to support a ring of fire bricks 67 which extends from the boiler casing 7 to the coarse filter 62, such that wood chips cannot flow past the coarse filter 62.

In particular, the webs 63, 64 or the radial inner webs 63 may be arranged at a cover 68, which may be inserted via pins 69 that protrude downwards at its underside into matching openings 70 in the top face 71 of the core 55, such that the rotation of the core 55 is transferred via the cover 68 to the webs 63, 64 or at least to the radial inner webs 63.

This coarse filter 62 is adjoined radially outside of it by an annular deflector 77, which forces larger pieces of charcoal radially outwards and thus keeps them away from the underlying funnel 70.

However, it has been shown that there is an increased tendency for wood gas condensate to precipitate on the cover 68 in the form of a tacky tar-like mass, which continuously serves as a seed for increasing precipitate and leads to gradual, but continuous clumping of tar-like condensate on the cover 68 on the top face 71 of the core 55. Such a clumping would continue to grow and clog the cross section necessary for feeding wood chips in the region below the air supply 14. Without an additional design structure, such a clumping on top of the cover 68 may even lead to clogging of the coarse filter 62 over time, with the result that the entire mechanism within the wood gas boiler 1 has to be disassembled and cleaned at regular short intervals, which would lead in each case to downtime of the wood gas boiler and thus of the entire installation.

In order to avoid this, a condensate deflector 72 is installed above the cover 68 which is to prevent the formation of such a clumping.

The deflector comprises cover 73 arched upwards in the middle, which slopes down radially to all sides. Because of its curvature, which may either be cup-shaped, or conical and/or cone-shaped, and comprised of a pure metal surface, any precipitated wood gas condensate is diverted radially outward and thus cannot settle on this cover 73. Here, the wood gas condensate flows only due to the force of gravity along the curvature of the cover 73 radially outward and thus reaches hotter regions of the wood gas boiler 1, where the wood gas condensate is cracked and thus cannot form a permanent precipitate.

The periphery of the cover 73 of the condensate deflector 72 is located above the coarse filter 62. In order to remove any remaining wood chips there, the cover 73 of the condensate deflector 72 is provided along its periphery with extensions 74 that protrude radially outward, for example in the shape of tabs. In order for these extensions 74 being able to slide over the coarse filter 62, the invention further provides that the condensate deflector 72 rotates with a different speed from the coarse filter 62 or the webs 63 thereof fixed to the core 55. This may, for example, be achieved by not rotating the condensate deflector 72 at all or by rotating it slower or faster than the core 55 or by rotating it in the opposite direction of the core 55.

In order to ensure this, the condensate deflector 72 is connected to the central axis 28 by means of a top extension 75 with cylinder-jacket shape in a rotationally fixed manner. For this purpose, the top extension 75 with cylinder-jacket shape may, for example, have slotted notches 76, in which a pin extending transversely to the shaft 28 may engage, in order to impart the rotational speed of the central shaft 28 onto the condensate deflector 72. This rotational speed is set at the lower end of the shaft 28, either by fixing the shaft 28 fixedly and non-rotatably there, or by coupling it with a drive which is preferably located below the boiler bottom 2.

The shaft 28 extending through the core 55 of the wood gas boiler 1 from the boiler bottom 2 thereof to the condensate deflector 72 couples a drive unit below the boiler bottom 2 with the condensate deflector 72 and thus allows imparting a different rotational speed onto the deflector than the assembly below, consisting of the coarse filter 62, the central core 55, the star 44, and the peripheral rim 41, which is connected to the central core 55 via rigid spokes in form of the sheets 39.

As intended, thanks to its central rotary drive, the condensate deflector 72 may not only rotate in the opposite direction of the above assembly, consisting of the coarse filter 62, the central core 55, the star 44, and the peripheral rim 41, or faster or slower than said assembly, or even be stationary; it may also, in contrast to said assembly, rotate continuously, whereas the assembly located underneath is only rotated from time to time, for example.

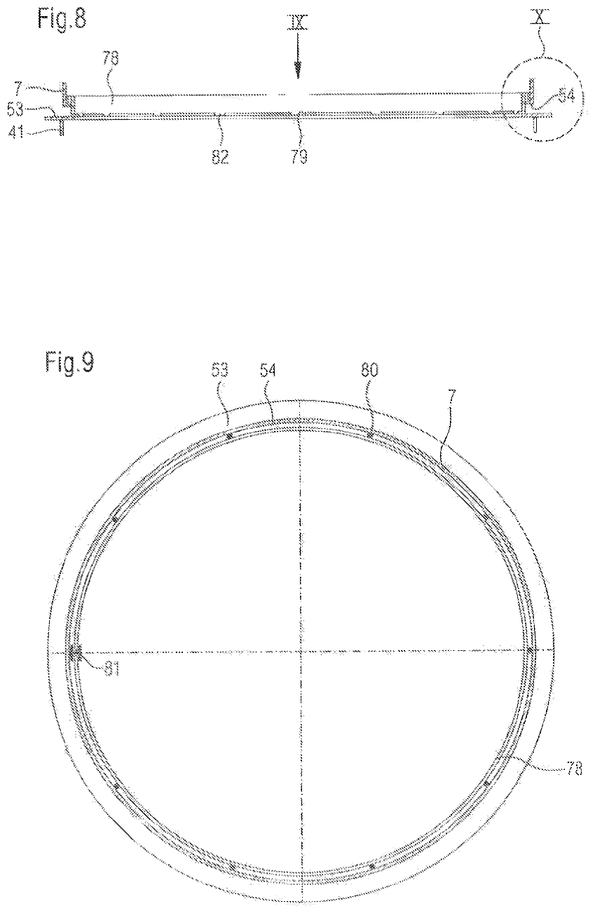

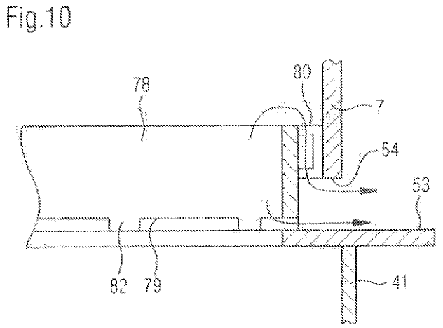

FIGS. 8 to 10 show an approximately annular sealing element 78 for sealing a circumferentially extending gap between the upper boiler casing 7, on one hand, and the peripheral jacket 41 of the rotatable insert, on the other hand. This element serves two purposes: On one hand, passage of the produced gas is to be enabled; on the other hand, larger wood, coal and ash particles are to be prevented to pass through, such that these cannot clog the enveloping gas extraction space within the lower boiler jacket 4.

The approximately jacket-shaped sealing element 78 consists of a metal strip curved into a ring having notch-shaped recesses 79 at its lower edge, which are separated from each other by comparably narrow webs 82 between the recesses 79. These recesses 79 are in turn relatively flat and allow the gas to pass through, but are too narrow for larger coal or ash residues.

At the outside of the sealing element 78, a plurality of spacers 80 are provided in the upper region, which may, for example, be formed by vertical, outwardly protruding sheets or hoops. These bridge the horizontal gap in the radial direction between the lower section 54 of the upper boiler casing 7 and the sealing element 78 accommodated therein at a radial distance and ensure that the approximately annular sealing element 78 is centered within the upper boiler casing 7. Between the spacers 80 spaced apart circumferentially, respective gap-like clearances remain that allow wood gas to pass through, but retain larger coal or ash particles.

In the sealing element 78, the two ends of the metal strip curved into a ring are preferably not connected to each other. A gap remains there, in which a driver 81 may engage, which is attached on the inner side 15 of the upper boiler casing 7 at the level of the sealing element 78 and protrudes radially inwards and engages through the gap between the ends of the metal strip of the sealing element 78 curved into a ring that face each other. Thereby, the sealing element 78 is fixed in a rotationally fixed manner with respect to the upper boiler casing 7 and is unable to rotate with the rotatable insert. This continuous relative motion prevents clogging of the recesses 79.

Radially inside of the annular, curved sealing element 78, the driver 81 may have bulges or even flanges which engage the sealing element 78 on the inside and thereby prevent it from being detached from the driver. Bulges or flanges on the driver 81 radially outside of the annular, curved sealing strip 78 may have a complementary guiding effect.

### LIST OF REFERENCE NUMERALS

1 wood gas boiler

2 boiler bottom

3 webs

4 lower boiler jacket

5 upper edge

6 flange

7 upper boiler casing

8 flange

9 outlet port

10 annulus

11 annulus

12 outer wall

13 boiler housing

14 air supply

15 inner side

16 air duct

17 clamp

18 outlet nozzles

19 ash grating

20 axis of symmetry

21 support arm

22 skirt

23 upper region

24 lower edge

25 support element

51 lateral surface

26 sleeve

27 cylindrical element

28 shaft

29 rotation device

30 ash remover

31 pipe

32 sleeve

33 cover

34 holes

35 webs

36 plate

37 hub-shaped element

38 outer face

39 sheet

40 end

41 jacket

42 vane

43 longitudinal axis

44 star

45 middle section

46 axle stub

47 toothing

48 tooth

49 finger

50 opening

76 slotted notch

52 openings

53 upper edge

54 lower edge

55 core

56 jacket

57 base

58 through hole

59 through hole

60 funnel-shaped element

61 rib

62 coarse filter

63 web

64 outer rim

65 web

66 web

67 fire brick

68 cover

69 pin

70 opening

71 top face

72 condensate deflector

73 cover

74 extension

75 extension

77 deflector

78 annular sealing element

79 recess

80 spacer

81 driver

82 web

1. A wood gas boiler (1) comprising a boiler housing (13), which is preferably partitioned into a boiler bottom (2), a lower boiler jacket (4), an upper boiler casing (7) and a boiler cover, wherein a device (14) for supplying air is arranged within the boiler housing, as well as at least one grating (19), wherein wood gas is generated in a firebed from wood chips on the grating (19), the wood gas being extractable by suction and/or removable to the outside, wherein a star (44) with a plurality of vanes (42) is provided in the region of the firebed above the grating (19), the longitudinal vane axes (43) extending in a star shape radially outward from a central vertical axis (20) of the wood gas boiler (1), characterized in that the vanes (42) are each supported to be rotatable about a respective axis of rotation extending radially with respect to the central vertical axis (20).

2. The wood gas boiler (1) according to claim 1, characterized by a rim (41) radially surrounding the star (44) on the outside and preferably rigidly connected to a central core or a hub (37) within the star (44), in particular through a plurality of star-shaped spokes or radial sheets (39).

3. The wood gas boiler (1) according to claim 1, characterized in that the vanes (42) are rotatably supported at their ends that are radially outer with respect to the central vertical axis (20), preferably at a rim (41) radially surrounding the star (44) on the outside.

4. The wood gas boiler (1) according to claim 1, characterized in that at least one vane (42) is provided with a support extension (46) at said vane's radially inner end and/or at said vane's radially outer end, preferably wherein at least one counterpart to a support extension (46) of a vane (42) is arranged at a rim (41) surrounding the star (44) radially on the outside and/or in the region of a central core or a hub (37) of the star (44), especially wherein a number of holes corresponding to the number of vanes (42) are provided in a rim (41) surrounding the star (44) radially on the outside, wherein said holes have a substantially circular cross section for one each of the support extensions (46) to pass through at the radially outer end of each vane (42) while maintaining a clearance which permits a rotation of the respective vane (42).

5.-72. (canceled)

73. The wood gas boiler (1) according to claim 1, characterized in that at least one vane (42) is coupled or may be coupled with at least one drive for rotation about an axis of rotation extending radially with respect to the vertical axis of rotation (20), preferably wherein the coupling of a drive to rotate a vane (42) about an axis of rotation extending radially with respect to the vertical axis of rotation (20) is carried out at the radially outer end of the respective vane (42), preferably at the radially outer support extension (46), in particular radially outside of a rim (41) surrounding the star (44) radially on the outside, especially wherein a vane (42) has a rotationally fixed toothing (47) to be rotationally driven at its radial outer end, preferably at the radially outer support extension (46), more preferably radially outside of a rim (41) surrounding the star (44) radially on the outside, the teeth of said toothing pointing radially outwards from the axis of rotation of the respective vane (42), for example wherein the driving is discontinuous for at least one vane (42).

74. The wood gas boiler (1) according to claim 1, characterized in that the star (44) having the plurality of vanes (42) may be rotated about the central vertical axis (20) of the wood gas boiler (1), preferably wherein the driving for at least one vane (42) is derived from a rotation of the star (44), especially wherein at least one fixed finger (49) or another preferably stationary barrier is provided, which, in a particular rotational position of the star (44), engages with a tooth (48) of the toothing (47) at a vane (42) and upon further rotation of the star (44) about its vertical axis of rotation (20) continues to rotate the vane (42) about its horizontal or radial axis of rotation.

75. The wood gas boiler (1) according to claim 74, characterized in that a drive mechanism is configured such that at least one of the star (44) and the rim (41)
a) may be rotated at predetermined time intervals, and/or
b) may be rotated incrementally, and/or
c) rotate for about one minute, after which about one quarter rotation has been covered, and such that the star (44) and the rim (41) are stationary for about 20 to 30 minutes thereafter.

76. The wood gas boiler (1) according to claim 1, characterized in that at least one vane (42) has an elongated shape having a longitudinal axis (43) which is parallel or coaxial to the axis of rotation extending radially with respect to the central vertical axis of rotation (20), preferably wherein at least one vane (42) has a profiled shape in a middle section between its supports or ends, especially wherein at least one vane (42) has a round or polygonal cross section in its profiled section.

77. The wood gas boiler (1) according to claim 1, characterized in that at least one vane (42) is at least sectionally hollow, preferably wherein at least one vane (42) has one or more openings (50) in its lateral surface (51) which allows wood gas to flow into or out of the cavity of the vane (42), especially wherein at least one opening (50) in the lateral surface (51) of a vane (42) is elongate in shape, wherein the longitudinal direction of the opening (50) is preferably oriented transversely to the axis of rotation of the respective vane (42).

78. The wood gas boiler (1) according to claim 77, characterized in that the cavity within at least one vane (42) extends through at least one support extension (46), preferably up to an opening in the free end face of the respective support extension (46), preferably wherein the opening is located in the free end face of the radial outer support extension (46) of the vane (42), preferably radially outside of the rim (41) of the star (44), especially in such a way that at least one vane (42) can serve to extract wood gas from the firebed which enters through the openings (50) in the lateral surface (51) of the vane (42) into a channel-shaped cavity within the vane (42) and exits the vane (42) at an opening at its end which is preferably coaxial, preferably at its radial outer end, more preferably radially outside of the rim (41) of the star (44).

79. The wood gas boiler (1) according to claim 1, characterized in that
a) a rim (41) surrounding the star (44) has one or more openings (52) for egress or suctional extraction of wood gas, and/or in that
b) a suction device is provided for suctioning the wood gas, wherein said suction device preferably passes the wood gas to a combustion drive motor which may preferably be coupled with an electrical generator for generating electrical energy.

80. The wood gas boiler (1) according to claim 1, characterized in that the upper boiler casing (7) does not extend down to the grating (19) in one piece, but is continued downwards through a lower boiler casing (41) which is located within the lower boiler jacket (4), and wherein a horizontally circumferential gap is located between the lower end (54) of the upper boiler casing (7) and the lower end (53) of the lower boiler casing (41), an annular seal being provided in the region of said gap and having a sealing element (78) which is made of a metal strip curved in a shape of a cylinder jacket and arranged concentrically to a central axis (20) of the upper boiler casing (7).

81. The wood gas boiler (1) according to claim 80, characterized in that the lower boiler casing
a) is supported to be rotatable about a central, vertical axis (20) of the wood gas boiler (1), and/or
b) is formed by a rim (41) radially surrounding the star (44) on the outside, the rim being preferably rigidly connected to a central core or a hub (37) within the star (44), in particular through a plurality of star-shaped spokes or radial sheets (39).

82. The wood gas boiler (1) according to claim 80, characterized in that said sealing element (78) is maintained at a distance from the upper boiler casing (7) in the radial direction by means of a plurality of radial spacers (80) arranged along the element's circumference, preferably wherein the radial spacers (80) are fixed to the sealing element (78) and protrude radially towards the upper boiler casing (7), especially wherein the radial spacers (80) on the sealing element (78) have a planar shape that lies in a vertical radial plane.

83. The wood gas boiler (1) according to claim 80, characterized in that the sealing element (78)
a) is neither integrated with the upper boiler casing (7) nor with the lower boiler casing (41), and/or
b) has a plurality of webs (82) at its lower end face arranged along its circumference protruding vertically downwards and rests with these webs on the upper edge (53) of the lower boiler casing (41), preferably wherein the upper edge (53) of the lower boiler casing (41) is embodied as a flat annual disc on which the sealing element (78) rests with its webs (82) which protrude vertically downwards.

84. The wood gas boiler (1) according to claim 80, characterized by a driver (81) which engages with the gap between the two ends of the annular sealing element (78) curved from a metal strip and is fixed to a support element, for example a boiler casing (4, 7, 41), such that the annular sealing element (78) cannot be rotated with respect to the respective support element, preferably wherein the driver (81) has a tab having a planar shape that lies in a vertical radial plane with respect to the central axis (20) of the wood gas boiler (2), especially wherein the driver (81) or its planar tab has ridges or extensions protruding tangentially with respect to the sealing element (78) curved in cylinder-jacket shape which guidedly encompass the sealing element (78) curved in cylinder-jacket shape at its inner and/or outer sides.

85. The wood gas boiler (1) according to claim 1, characterized by a central core (55) in the shape of a jacket (56) which encloses a central region of the wood gas boiler (1) and has at least one circumferential series of openings or through holes (58, 58) to allow an exchange of wood chips and charcoal between a central region and a peripheral region of the wood gas boiler (1).

86. The wood gas boiler (1) according to claim 85, characterized in that the jacket (56) of the central core (55) of the wood gas boiler (1)
a) is located at the level of said sealing element (78), and/or
b) has a rotationally symmetric or cylindrical shape, preferably a circular cylindrical shape, or a prismatic shape, preferably having a cross section in the shape of a regular polygon.

87. The wood gas boiler (1) according to claim 85, characterized in that the central, jacket-shaped core (55) of the wood gas boiler (1)
a) comprises an outer diameter or a mean outer diameter, which corresponds to at least one third of the boiler diameter in the region of the upper boiler casing (7), and/or
b) is vertically penetrated by a central rod or shaft (28).

88. The wood gas boiler (1) according to claim 85, characterized in that the central, jacket-shaped core (55) of the wood gas boiler (1) is closed off, or stabilized and/or reinforced at the bottom by a circular, polygonal and/or annular base plate (57), preferably wherein the central, jacket-shaped core (55) of the wood gas boiler (1) may be set into rotary motion about its central vertical axis (20) by a mechanism underneath its base plate (57), especially wherein the core (55) is connected to a hub-shaped body (37) of the star (44) arranged below the core (55) and/or below the core's base plate (57) in a rotationally fixed manner.

89. The wood gas boiler (1) according to claim 85, characterized in that the lateral surface (56) of the core (55) of the wood gas boiler (1)
a) comprises a first, upper, circumferential series of through holes (58), preferably for ingress of wood particles, coal particles or ash particles into the core (55), and/or
b) comprises a second, lower, circumferential series of through holes (59), preferably for egress of wood particles, coal particles or ash particles from the core (55),
preferably wherein the width of a through hole (58, 59) in the lateral surface (56) of the core (55) is constant in its lower region and tapers from top to bottom in its upper region, especially wherein the through holes (58, 59) in the lateral surface of the core (55) are shaped in the manner of a triangular, rectangular or pentagonal window or an arched window.

90. The wood gas boiler (1) according to claim 85, characterized in that the lateral surface of the core (55) is surrounded by a bell-shaped or funnel-shaped or conical body at a level between the upper through holes (58) and the lower through holes (59), preferably wherein the bell-shaped or funnel-shaped or conical body surrounding the central, jacket-shaped core of the wood gas boiler (1) on the outside expands from bottom to top, and/or wherein preferably the lateral surface of the central, jacket-shaped core of the wood gas boiler (1) is surrounded by a filter, preferably a coarse filter (62), above the bell-shaped or funnel-shaped or conical body.

91. The wood gas boiler (1) according to claim 85, characterized in that the central, jacket-shaped core (55) of the wood gas boiler (1)
a) is reinforced or stabilized by vertical ribs (61) located preferably at the inside of the lateral surface of the core (55), and/or
b) is closed off, or stabilized and/or reinforced at the top by a circular, polygonal and/or annular end wall.

92. The wood gas boiler (1) according to claim 1, characterized by a central condensate deflector (72) which covers a central region within the wood gas boiler (1) and is to prevent a deposit of wood chips and/or charcoal in this region.

93. The wood gas boiler (1) according to claim 92, characterized in that the condensate deflector (72) rests on said top end wall of the central, jacket-shaped core (55), preferably wherein the condensate deflector (72) covers the central, jacket-shaped core (55) of the wood gas boiler (1) and/or its upper circular, polygonal and/or annular end wall at the periphery thereof completely.

94. The wood gas boiler (1) according to claim 92, characterized in that the condensate deflector (72) has a planar or annular region (73) surrounding a central axis (20) of the wood gas boiler (1) and having a closed surface, preferably wherein said planar or annular region (73) of the condensate deflector (72) with a closed surface is of a point symmetric or rotationally symmetric shape, especially wherein said planar or annular region (73) with a closed surface is elevated near its center or near its inner edge with respect to its periphery or its outer edge.

95. The wood gas boiler (1) according to claim 92, characterized in that the condensate deflector (72) or its annular region (73) with a closed surface
a) has a hood-, cap- or cone-shaped geometry, and/or
b) has an outer diameter, which corresponds to one third or more of the boiler diameter in the region of the upper boiler casing (7).

96. The wood gas boiler (1) according to claim 92, characterized in that a filter, preferably a coarse filter for retaining larger wood or coal pieces, is arranged at a level below the condensate deflector (72), preferably wherein the condensate deflector (72) has at least one radially protruding extension at its outer perimeter, which is to scrape or strip off contaminants from the upper side of the filter or coarse filter located underneath, especially wherein the condensate deflector (72) has a different rotational speed compared to the filter or coarse filter located underneath, for example a rotational speed in the opposite direction.

97. The wood gas boiler (1) according to claim 92, characterized in that the condensate deflector (72)
a) is rotationally fixedly coupled with a vertical shaft (28) in the region of its center or of the inner edge of its annular region (73) and is fixed or driven in the direction of rotation by means of this vertical shaft (28), and/or
b) rests, via its annular region (73), on a structure arranged underneath and is supported and/or stabilized in its position by said structure, for example by a support structure resting on said top end wall of the central, jacket-shaped core (55).
